(19) United States
(12) Patent Application Publication
(10) Pub. No.: US 2022/0336143 A1
(43) Pub. Date: Oct. 20, 2022

(54) HYBRID FERROMAGNETIC CORE

(71) Applicant: Apple Inc., Cupertino, CA (US)

(72) Inventors: Zelin Xu, San Jose, CA (US); Sumant Ranganathan, Saratoga, CA (US); Matthew J. Chabalko, Salinas, CA (US); Nan Liu, Sunnyvale, CA (US); Eric X. Zhou, San Jose, CA (US)

(21) Appl. No.: 17/718,854

(22) Filed: Apr. 12, 2022

Related U.S. Application Data
(60) Provisional application No. 63/176,081, filed on Apr. 16, 2021.

(51) Int. Cl. H01F 27/30; H02J 50/10; H02J 50/00; H01F 27/24; H01F 1/34; H01F 41/04; H01F 41/02

(52) U.S. Cl. CPC H01F 27/306; H02J 50/10; H02J 50/005; H01F 27/24; H01F 1/344; H01F 41/04; H01F 41/0206

(57) ABSTRACT

The disclosure is directed to wireless power systems that include a ferromagnetic core formed of nanocrystalline material disposed on a ferrite. The wireless power systems can have reduced saturation and/or lossiness.

### PRIORITY

The disclosure claims the benefit under 35 U.S.C. § 119(e) of U.S. Provisional Patent Application No. 63/176,081, entitled “Hybrid Ferromagnetic Core”, filed on Apr. 16, 2021, which is incorporated herein by reference in its entirety.

### FIELD

The disclosure is directed to wireless power systems that include ferromagnetic cores formed of a nanocrystalline material disposed on a ferrite.

### BACKGROUND

A wireless power transmitter assembly in a primary electronic device can be aligned with a wireless power receiver assembly in a receiving device. A wireless power transmitter coil disposed in the transmitter assembly produces magnetic flux, which induces a current in a corresponding receiving coil in the receiving device. The induced current can be used to charge a battery in the receiving device. Magnetic components, such as ferrite, used in the transmitter and/or receiver assemblies can saturate under some operating conditions, which decreases the effectiveness of wireless power transfer operations.

### SUMMARY

In one aspect, the disclosure is directed to a transmitter assembly including a transmitter coil wound around a ferromagnetic core. The ferromagnetic core includes a nanocrystalline material disposed on a ferrite.

In another aspect, the disclosure is directed to an inductive power transfer assembly including the transmitter assembly and a receiver assembly. The receiver assembly includes a receiver coil. The transmitter coil is configured to be aligned with the receiver coil.

In another aspect, the disclosure is directed to method of making the transmitter assembly. A nanocrystalline material is deposited onto a ferrite material to form a ferromagnetic core. A transmitter coil is wound around ferromagnetic core.

### BRIEF DESCRIPTION OF THE DRAWINGS

The description will be more fully understood with reference to the following figures, which are presented as various embodiments of the disclosure and should not be construed as a complete recitation of the scope of the disclosure, wherein:

FIG. 1A is a illustrates a portable electronic device having a transmitter assembly, in accordance with illustrative embodiments of the disclosure;

FIG. 1B illustrates a receiving device having a receiver assembly, in accordance with illustrative embodiments of the disclosure;

FIG. 2A illustrates a transmitter assembly coupled to a receiving device having a receiver assembly, in accordance with illustrative embodiments of the disclosure;

FIG. 2B illustrates a ferromagnetic core in which a nanocrystalline material is disposed on every surface of a ferrite, in accordance with illustrative embodiments of the disclosure; and

FIG. 2C illustrates a ferromagnetic core in which a nanocrystalline material is disposed on less than all of the surfaces of a ferrite, in accordance with illustrative embodiments of the disclosure.

### DETAILED DESCRIPTION

A wireless power system has a wireless power transfer assembly that transmits power wirelessly to a wireless power receiver assembly. In some implementations the transmitter assembly is incorporated into a power transmitter that is coupled to mains electricity, and the receiver assembly is incorporated into a battery-powered portable device such as a cellular phone. In some implementations the transmitter assembly is itself incorporated into a battery-powered electronic device, and the receiver assembly is incorporated into a battery-powered electronic device, such as an electronic pencil, stylus, or other peripheral device.

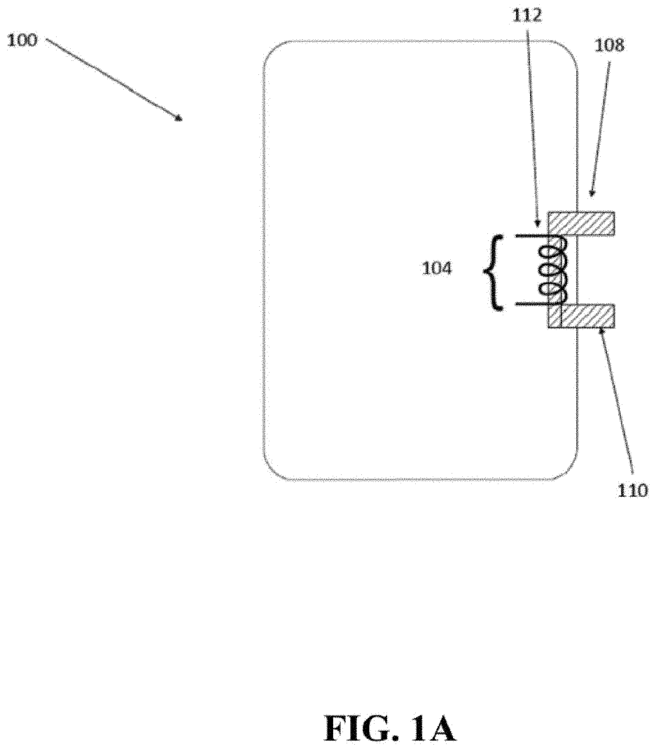

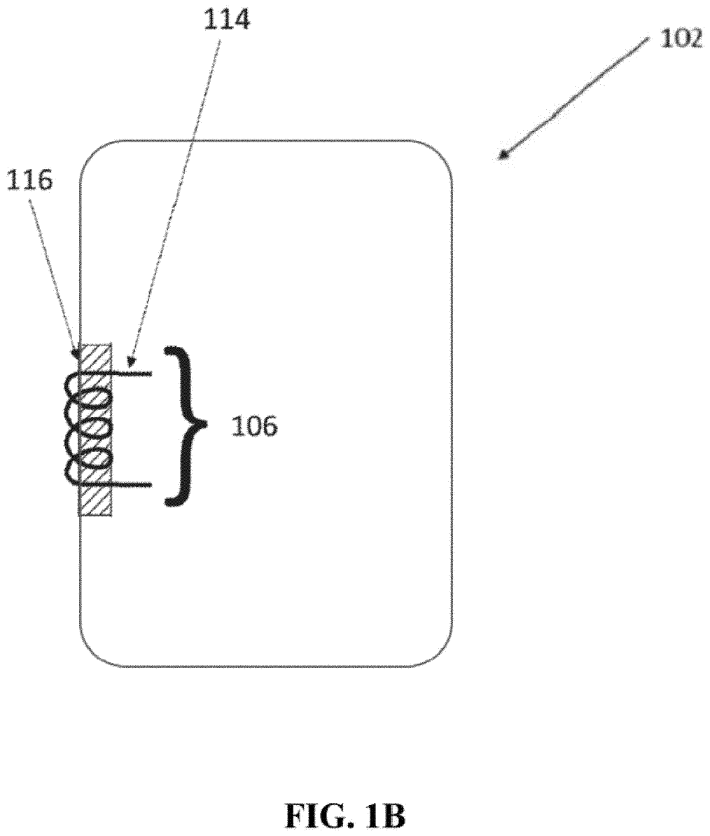

FIG. 1A illustrates transmitter assembly 104 in electronic device 100. Transmitter assembly 104 includes a ferromagnetic core 108 having a base 110. Base 110 is u-shaped in the illustrated example. A transmitter coil 112 is wound around the central portion of base 110. AC current is transmitted through the transmitter coil 112 to generate magnetic flux. Ferromagnetic core 108 can shape and/or direct the magnetic flux.

FIG. 1B illustrates receiver assembly 106 in receiving device 102. Receiver assembly 106 includes ferromagnetic core 116. Receiver coil 114 is wound around ferromagnetic core 116. Magnetic flux induces a current in receiver coil 114. An AC-DC power converter (not shown) then converts AC power from receiver coil 114 into DC power, which can be stored in a battery (not shown) of receiving device 102.

An inductive power transfer assembly can include a transmitter assembly and a receiver assembly. During operation, AC current can be transmitted through the transmitter coil to generate magnetic flux. The ferromagnetic core can shape and/or direct the magnetic flux to induce a current in the receiver coil of the receiver assembly. An AC-DC power converter can then convert AC power from receiver coil into DC power, which can be stored in a battery of receiving device.

In various aspects, transmitter assembly 104 and receiver assembly 106 are inductively coupled with each other to facilitate efficient power transfer. Typically, this is achieved by physically aligning transmitter coil 112 and receiver coil 114 in close proximity.

As the form factor of electronic device 100 become smaller, the components such as inductive power transfer assemblies also become smaller. This includes the components of transmitter assembly 104, such as ferromagnetic core 108 and transmitter coil 112. To transfer the same amount of power to receiving device 102 and maintain the same user experience, higher current is driven across transmitter coil 112. A higher current produces a larger magnetic flux density.

In inductive power assemblies in which ferromagnetic core 108 includes only ferrite, ferromagnetic core 108 can approach magnetic flux saturation. Increased current in transmitter coil 112 also generates more heat, which also heats the ferrite in the ferromagnetic core 108. The ferrite can lose structural and/or material properties, resulting in reduced inductance. In some instances, the voltage and/or current waveforms induced in the receiver coil 114 can change, resulting in voltage and/or current spikes. At higher currents, coil inductance drops, and the impedance of the system drops, resulting in a feedback loop that further decreases the effectiveness of wireless power transfer operation.

Ambient magnetic fields, such as those produced by permanent magnets designed to attach peripheral devices to primary electronic devices can further exacerbate inconsistent transmission caused by magnetic flux saturation and heating at the ferromagnetic core. With reference to FIGS. 1A and 1B, when receiving device 102 is attached to a device by permanent magnets (not shown), the permanent magnets introduce a DC magnetic flux biased in a single direction. As the AC current in transmitter coil 112 alternates, DC magnetic flux from the permanent magnets can add to, then oppose (e.g., bias), the AC magnetic flux generated by transmitter coil 112. As a result, an asymmetric magnetic flux is transmitted to receiver coil 114.

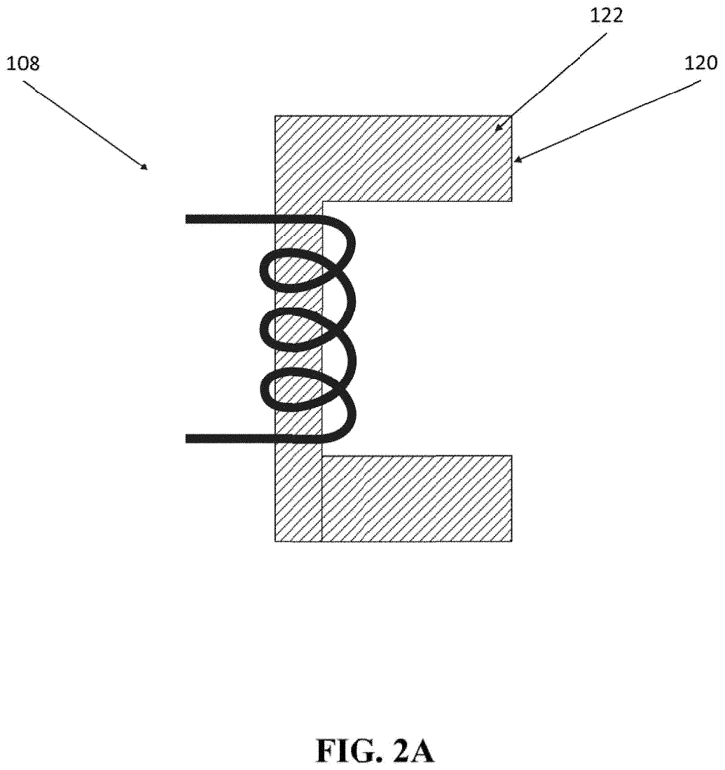

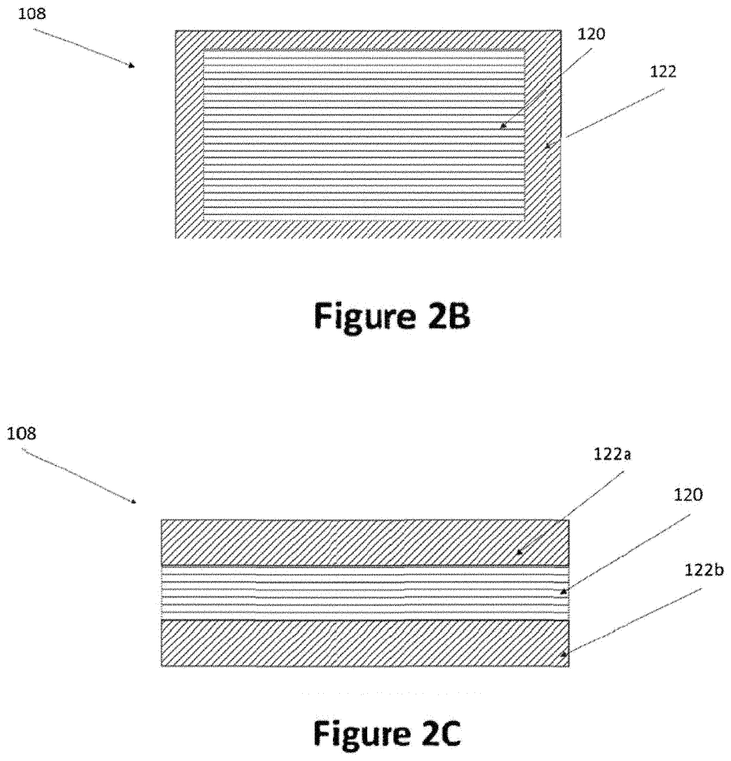

With reference to FIG. 2A, ferromagnetic core 108 includes nanocrystalline material 122 disposed on ferrite 120. Transmitter coil 112 is wound around ferromagnetic core 108. The nanocrystalline material can be disposed on the on all ferrite surfaces, disposed on a one or more ferrite surfaces, or at least partially disposed on one or more ferrite surfaces. In one variation, as depicted in FIG. 2B, ferromagnetic core 108 includes nanocrystalline material 122 disposed on all surfaces of ferrite 120. In another variation, as depicted in FIG. 2C, ferromagnetic core 108 includes nanocrystalline material on less than all of the ferrite surfaces. As can be seen in FIG. 2C, a first layer of nanocrystalline material 122a is disposed on a first surface of ferrite 120, and a second layer of nanocrystalline material 122b is disposed on a second surface of ferrite 120. Nanocrystalline materials can be disposed on any number of ferrite surfaces, whether those surfaces oppose or adjoin.

Nanocrystalline material 122 can be disposed on ferrite 120 by any method known in the art. For example, nanocrystalline material 122 can be disposed on ferrite as part of a “stack-up,” i.e., two or more layers stacked together, optionally with an adhesive and/or other materials disposed between adjacent layers. In another variation, nanocrystalline material 122 can be disposed on ferrite 120 by coating one or more surfaces of ferrite 120 with nanocrystalline material 122. In some variations, nanocrystalline material 122 can be laminated onto one or more surfaces of ferrite 120.

Nanocrystalline material disposed on ferrite (also referred to herein as a “hybrid ferrite-nanocrystalline”) can provide benefits of both materials, particularly in devices with lower form factors.

In a hybrid ferrite-nanocrystalline ferromagnetic core, ferrite can provide the benefit of a stiff frame, ease of manufacture, particularly during coil winding, and relatively low lossiness. However, ferrite alone can have a relatively low magnetic flux saturation density (e.g., a Bₛₐₜ of ˜0.45 T) as compared to nanocrystalline materials. As such, increased magnetic flux can result in saturation and resulting structural and/or material loss, increased inductance, and reduced impedance as described herein. Ferrites that are not as resistant to temperature can also have a relatively lower flux saturation density as compared to nanocrystalline materials. By contrast, nanocrystalline materials can absorb a higher saturation flux density, but are lossier than ferrite. Nanocrystalline materials can also be more fragile.

A hybrid ferrite-nanocrystalline structure provides benefits of both materials during operation of inductive power assemblies. The rigidity of the ferrite material provides structural support for the ferromagnetic core. The permeability of the nanocrystalline material can be designed to be lower than ferrite, but high enough so that when ferrite saturates, the nanocrystalline material permeability will not result in an appreciable inductance drop.

During operation of inductive power assemblies that have a ferromagnetic core formed of the ferrite-nanocrystalline hybrid, magnetic flux concentrates in ferrite. In the low current portion of the AC cycle, the magnetic flux flows to the ferrite. In the high current portion of the AC cycle, the ferrite begins to saturate, and its permeability drops. When ferrite permeability drops to a level that approaches the permeability of the nanocrystalline material, magnetic flux begins to flow to the nanocrystalline material. Though the nanocrystalline material has higher lossiness, the saturation of the system is reduced as compared ferromagnetic core including ferrite alone.

The mechanical dimensions and relative amounts of the ferrite and nanocrystalline material can be selected, or “tuned,” such that both saturation and lossiness of the system are reduced and/or minimized. In some variations, the ratio of the ferrite and nanocrystalline material thicknesses, and/or the ratio of the ferrite and nanocrystalline material volume, can be selected for their relative effect on saturation and loss.

The ferrite can be selected for a particular frequency. For example, for frequencies of wireless power transfer operation in the 100-400 kHz range, a MnZn ferrite can be selected. At wireless power transfer operating frequencies in the MHz range, a NiZn ferrite can be selected. The choice of ferrite can depend on the lowest loss material for specific operating frequencies.

The amount of nanocrystalline material can be adjusted to reduce saturation and lossiness. Lossiness is frequency dependent, and nanocrystalline materials can be lossier than ferrites in systems employing those frequencies of operation. In some variations, increasing the relative amount of nanocrystalline material can result in reduced magnetic flux saturation in the ferromagnetic core. Increasing the relative amount of nanocrystalline material can also result in increased lossiness.

In some variations, the relative percent thicknesses of ferrite and nanocrystalline material can be adjusted. The thickness of the ferromagnetic core can be described in terms of the percent thickness of ferrite and percent thickness of nanocrystalline material. For example, the thickness of each material in the ferromagnetic core can be in the ranges of 60%-90% ferrite and 10%-40% nanocrystalline material. In some instance where the percent thickness of the ferromagnetic core is described in terms of percent ferrite, the percent thickness of nanocrystalline material can be assumed to be the remainder.

In some variations, the ferrite thickness is at least 60% of the total thickness of the ferromagnetic core. In some variations, the ferrite thickness is at least 65% of the total thickness of the ferromagnetic core. In some variations, the ferrite thickness is at least 70% of the total thickness of the ferromagnetic core. In some variations, the ferrite thickness is at least 75% of the total thickness of the ferromagnetic core. In some variations, the ferrite thickness is at least 80% of the total thickness of the ferromagnetic core. In some variations, the ferrite thickness is at least 85% of the total thickness of the ferromagnetic core.

In some variations, the thickness of the ferrite component is equal to or less than 90% of the total thickness of the ferromagnetic core. In some variations, the thickness of the ferrite component is equal to or less than 85% of the total thickness of the ferromagnetic core. In some variations, the thickness of the ferrite component is equal to or less than 80% of the total thickness of the ferromagnetic core. In some variations, the thickness of the ferrite component is equal to or less than 75% of the total thickness of the ferromagnetic core. In some variations, the thickness of the ferrite component is equal to or less than 70% of the total thickness of the ferromagnetic core. In some variations, the thickness of the ferrite component is equal to or less than 65% of the total thickness of the ferromagnetic core.

In some variations, the relative amount of ferrite is 75% of the total thickness of the ferromagnetic core and the with the nanocrystalline material is 25% of the total thickness of the ferromagnetic core.

In some variations, the thickness of the electronic device is from 0.65 to 0.75 cm. In some variations, the thickness of the electronic device is from 0.50 to 0.65 cm. In some variations, the thickness of the electronic device is from 0.45 to 0.50 cm. In some variations, the thickness of the electronic device is from 0.30 to 0.45 cm. The relative thickness of the ferrite and nanocrystalline material can be determined based on the percentages described.

In some variations, the amount of ferrite and nanocrystalline material can be tuned to provide a lower drop in inductance. Permeability range depends on what the acceptable saturation level. The permeability of the ferrite and nanocrystalline material can be modified, or “tuned,” to a specific amount or relative amounts.

Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Having described several embodiments, it will be recognized by those skilled in the art that various modifications, alternative constructions, and equivalents may be used without departing from the spirit of the disclosure. Additionally, well-known processes and elements have not been described in order to avoid unnecessarily obscuring the disclosure. Accordingly, the above description should not be taken as limiting the scope of the disclosure.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

1. A transmitter assembly comprising:
a transmitter coil wound around a ferromagnetic core, the ferromagnetic core comprising a nanocrystalline material disposed on a ferrite.

2. The transmitter assembly according to claim 1, Wherein the ferromagnetic core has a U-shaped base.

3. The transmitter assembly according to claim 2, wherein the transmitter coil is wound around a central portion of the U-shaped base.

4. The transmitter assembly according to claim 1, Wherein the ferrite is a MnZn ferrite.

5. The transmitter assembly according to claim 1, wherein the ferrite is a NiZn ferrite.

6. The transmitter assembly according to claim 1, wherein 60% to 90% of the thickness of the ferromagnetic core is ferrite and 10% to 40% of the thickness of the ferromagnetic core is a nanocrystalline material.

7. An inductive power transfer assembly comprising:
a transmitter assembly comprising a transmitter coil wound around a ferromagnetic core, the ferromagnetic core comprising a nanocrystalline material disposed on a ferrite; and
a receiver assembly comprising a receiver coil,
wherein the transmitter coil is configured to be aligned with the receiver coil.

8. The inductive power transfer assembly according to claim 7, wherein the transmitter assembly is disposed in a primary electronic device and the receiver assembly is disposed in a peripheral device.

9. The inductive power transfer assembly according to claim 7, wherein the ferromagnetic core is configured such that during operation a low current portion of an AC cycle, magnetic flux flows to the ferrite, and during a high current portion of the AC cycle, magnetic flux flows to the nanocrystalline material.

10. The inductive power transfer assembly according to claim 7, wherein the transmitter assembly is an electronic device has a width of less than 0.75 cm.

11. The inductive power transfer assembly according to claim 7, wherein the transmitter coil is wound around a central portion of the U-shaped base.

12. An electronic device comprising:
a primary electronic device comprising a transmitter assembly, the transmitter assembly comprising a transmitter coil wound around a ferromagnetic core, the ferromagnetic core comprising a nanocrystalline material disposed on a ferrite; and
a peripheral electronic device comprising a receiver coil.

13. The electronic device of claim 12, Wherein the primary electronic device comprises one or more permanent magnets configured to attach the peripheral device to the primary electronic device.

14. The electronic device of claim 12, wherein the ferromagnetic core has a U-shaped base.

15. The electronic device of claim 13, wherein the transmitter coil is wound around a central portion of the U-shaped base.

16. The electronic device of claim 12, wherein the ferrite is a MnZn ferrite or a NiZn ferrite.

17. A method of making a transmitter assembly, the method comprising:
depositing nanocrystalline material onto a ferrite to form a ferromagnetic core; and
winding the transmitter coil around ferromagnetic core.

18. The method according to claim 17, wherein the depositing step comprises laminating one or more sheets of the nanocrystalline material onto the ferrite material.

19. The method according to claim 17, wherein the depositing step comprises forming a stack-up of the nanocrystalline material on a ferrite with an adhesive disposed therebetween.

20. The method according to claim 17, wherein the depositing step comprises coating the ferrite with the nanocrystalline material.
